(19) United States
(12) Patent Application Publication
(10) Pub. No.: US 2014/0145954 A1
(43) Pub. Date: May 29, 2014

(54) MOUSE DEVICE OPERABLE IN SOUND MODE OR SILENT MODE

(71) Applicant: PRIMAX ELECTRONICS LTD., Neihu (TW)

(72) Inventor: Jian-Bin Wu, Neihu (TW)

(73) Assignee: PRIMAX ELECTRONICS LTD., Neihu (TW)

(21) Appl. No.: 13/749,314

(22) Filed: Jan. 24, 2013

(30) Foreign Application Priority Data
Nov. 27, 2012 (CN) 201210490866.6

(51) Int. Cl. G06F 3/0354

(52) U.S. Cl. CPC G06F 3/03543
USPC 345/163

(57) ABSTRACT

A mouse device is operable in a sound mode or a silent mode. The mouse device includes a casing, a tactile-feel wheel module, a sound button module, a third-axis control module, and a silent button module. The tactile-feel wheel module and the sound button module are disposed on the casing, and located near a first end of the casing. In a case that the mouse device is in the sound mode, the tactile-feel wheel module and the sound button module are enabled. The third-axis control module and the silent button module are disposed on the casing, and located near a second end of the casing. In a case that the mouse device is in the silent mode, the third-axis control module and the silent button module are enabled.

### FIELD OF THE INVENTION

The present invention relates to an input device, and more particularly to a mouse device with a scroll wheel.

### BACKGROUND OF THE INVENTION

The widely-used input device of a computer includes for example a mouse device, a keyboard device, a trackball device, a touchpad device, or the like. Among these input devices, the mouse device is the most prevailing because it is very easy-to-use for most users. When a mouse device is held by the palm of a user, the user may move the mouse device to control movement of a cursor shown on a display screen of a computer monitor.

Hereinafter, the structures and the functions of a conventional mouse device will be illustrated with reference to FIGS. 1 and 2. FIG. 1 schematically illustrates the connection between a conventional mouse device and a computer system. FIG. 2 is a schematic perspective view illustrating a portion of the inner structure of the conventional mouse device. The computer system 2 comprises a computer host 21 and a display screen 22. The computer host 21 is in communication with a mouse device 1 and the display screen 22. The computer host 21 has a connecting port 211. A graphic-based window 221 and a cursor 222 are shown on the display screen 22. The mouse device 1 is used for controlling the cursor 222 to have the computer host 21 execute a corresponding command. The mouse device 1 comprises a casing 10, a left button module 11, a right button module 12, a wheel module 13, a connecting wire 14, and a connector 15. The casing 10 is used for supporting the user's palm. When the casing 10 is moved by the user, a displacement amount of the casing 10 is detected. According to the displacement amount, the mouse device 1 generates a corresponding cursor displacement signal. According to the cursor displacement signal, the cursor 222 shown on the display screen 22 is correspondingly moved.

The left button module 11 comprises a left button part 111 and a left micro switch 112. The left button part 111 is located at a first side of the wheel module 13. Moreover, the left button part 111 is exposed outside the casing 10 to be pressed or tapped by the user. The left micro switch 112 is disposed on the casing 10, and located under the left button part 111. When the left micro switch 112 is triggered by the left button part 111, the left micro switch 112 issues a left button signal. According to the left button signal, the computer host 21 executes a corresponding command. Similarly, the right button module 12 comprises a right button part 121 and a right micro switch 122. The right button part 121 is located at a second side of the wheel module 13. Moreover, the right button part 121 is exposed outside the casing 10 to be pressed or tapped by the user. The right micro switch 122 is disposed on the casing 10, and located under the right button part 121. When the right micro switch 122 is triggered by the right button part 121, the right micro switch 122 issues a right button signal. According to the right button signal, the computer host 21 executes a corresponding command.

The wheel module 13 is located near a first end of the casing 10, and arranged between the left button module 11 and the right button module 12. The wheel module 13 comprises a scroll wheel 131, a rotating shaft 132, an encoder 133, and a contacting rod 134. The scroll wheel 131 is disposed on the casing 10. Moreover, the scroll wheel 131 is exposed outside the casing 10 to be rotated by the user. The rotating shaft 132 is penetrated through the scroll wheel 131, and synchronously rotatable with the scroll wheel 131. The encoder 133 is disposed on the casing 10, and located at a first side of the scroll wheel 131. A first end 1321 of the rotating shaft 132 is inserted into the encoder 133. As the scroll wheel 131 is rotated and the rotating shaft 132 is synchronously rotated with the scroll wheel 131, the encoder 133 issues a window scrolling signal. According to the window scrolling signal, the graphic-based window 221 is correspondingly scrolled by the computer host 21. The rotating shaft 132 comprises a graduation structure 1323. The graduation structure 1323 is disposed on a second end 1322 of the rotating shaft 132. The contacting rod 134 may be contacted with the graduation structure 1323. As the scroll wheel 131 is rotated, the contact between the contacting rod 134 and the graduation structure 1323 results in a tactile feel. The tactile feel may provide a feedback feel about the rotation of the scroll wheel 131 to the user. An end of the connecting wire 14 is connected with the connector 15. The above signals may be transmitted from the mouse device 1 through the connecting wire 14. Moreover, the connector 15 is inserted into the connecting port 211 of the computer host 21. Consequently, the mouse device 1 is in communication with the computer host 21 through the connecting wire 14. The mouse device with basic functions has been mentioned above.

During operations of the conventional mouse device 1, if the left button module 11 is tapped or pressed by the user, the left micro switch 112 will be triggered by the right button part 111. Due to the inner structure of the left micro switch 112, the left micro switch 112 generates a clicking sound. The clicking sound may provide a feedback feel about the tapping or pressing action of the left button module 11 to the user. The operations of the right button module 12 are similar to those of the left button module 11, and are not redundantly described herein. Moreover, in response to the tactile feel generated by the operating wheel module 13, the contact between the contacting rod 134 and the graduation structure 1323 also generates a consecutive clicking sound.

However, in a case that the mouse device 1 is used in a quiet environment (e.g. in a conference room), the clicking sound generated by the left button module 11, the right button module 12 or the wheel module 13 may annoy the participants of the meeting. For solving this drawback, a silent mouse device without making any clicking sound is introduced into the market. The silent mouse device is suitably used in the quiet environment. In the silent mouse device, the operations of the left button module and the right button module do not generate the clicking sound, and the operation of the wheel module does not result in the tactile feel. However, most users are not accustomed to the use of the silent mouse device. For meeting the expectations of all users, there is a need of providing a mouse device operable in a sound mode or a silent mode.

### SUMMARY OF THE INVENTION

The present invention provides a mouse device that is operable in a sound mode or a silent mode.

In accordance with an aspect of the present invention, there is provided a mouse device. The mouse device is operable in a sound mode or a silent mode. The mouse device is in communication with a computer system for controlling a movement of a cursor of the computer system. The mouse device includes a casing, a tactile-feel wheel module, a sound button module, a third-axis control module, and a silent button module. The tactile-feel wheel module is disposed on the casing, and located near a first end of the casing. As the tactile-feel wheel module is rotated, a window of the computer system is correspondingly controlled to be scrolled. The sound button module is located near the tactile-feel wheel module for issuing at least one sound button signal to the computer system. The third-axis control module is disposed on the casing and located near a second end of the casing for controlling the window of the computer system to be scrolled. The silent button module is located near the third-axis control module for issuing at least one silent button signal to the computer system.

In an embodiment, the mouse device includes an upper cover for covering the casing. The upper cover includes a perforation, a first triggering part, a second triggering part, and a covering part. The perforation is located near a first end of the upper cover. When the casing is covered by the upper cover, the tactile-feel wheel module or the third-axis control module is exposed outside the upper cover. The first triggering part is disposed on a bottom surface of the upper cover and located at a first side of the perforation for triggering the sound button module or the silent button module. The second triggering part is disposed on the bottom surface of the upper cover and located at a second side of the perforation for triggering the sound button module or the silent button module. The covering part is located near a second end of the upper cover. When the casing is covered by the upper cover, the tactile-feel wheel module or the third-axis control module is covered by the covering part.

In an embodiment, the sound button module includes a first micro switch and a second micro switch. The first micro switch is located at a first side of the tactile-feel wheel module. When the first micro switch is pressed by the first triggering part, the first micro switch generates a first sound button signal. The second micro switch is located at a second side of the tactile-feel wheel module. When the second micro switch is pressed by the second triggering part, the second micro switch generates a second sound button signal. If the mouse device is operated in the sound mode, the first micro switch is disposed under the first triggering part, and the second micro switch is disposed under the second triggering part.

In an embodiment, the silent button module includes a first silent switch and a second silent switch. The first silent switch is located at a first side of the third-axis control module. When the first silent switch is pressed by the first triggering part, the first silent switch generates a first silent button signal. The second silent switch is located at a second side of the third-axis control module. When the second silent switch is pressed by the second triggering part, the second silent switch generates a second silent button signal. If the mouse device is operated in the silent mode, the first silent switch is disposed under the first triggering part, and the second silent switch is disposed under the second triggering part.

In an embodiment, each of the first silent switch and the second silent switch is a mechanical silent switch, a Hall silent switch or a photoelectric silent switch.

In an embodiment, the tactile-feel wheel module includes a scroll wheel, an encoder, a graduation structure, and a contacting element. The scroll wheel is disposed on the casing, partially penetrated through an opening of the casing and exposed outside a top surface of the casing, so that the scroll wheel is permitted to be rotated. The encoder is connected with the scroll wheel. As the scroll wheel is rotated, the encoder issues a window scrolling signal to the computer system for controlling the window to be scrolled. The graduation structure is synchronously rotated with the scroll wheel. The contacting element is contacted with the graduation structure. As the scroll wheel is rotated, a tactile feel is generated.

In an embodiment, the third-axis control module includes a scroll wheel and an encoder. The scroll wheel is disposed on the casing, partially penetrated through an opening of the casing and exposed outside a top surface of the casing, so that the scroll wheel is permitted to be rotated. The encoder is connected with the scroll wheel. As the scroll wheel is rotated, the encoder issues a window scrolling signal to the computer system for controlling the window to be scrolled.

In an embodiment, the third-axis control module is disposed on a top surface of the casing. Moreover, the third-axis control module is a capacitive touchpad, a resistive touchpad, an optical finger navigation (OFN) module or a membrane switch circuit module.

In an embodiment, the mouse device further includes a displacement sensing module. The displacement sensing module is disposed within the casing and partially exposed to a bottom part of the casing. According to a movement of the casing on a working plane, the displacement sensing module issues a cursor displacement signal for controlling the movement of the cursor of the computer system.

In an embodiment, the displacement sensing module includes a light source, a reflective mirror, a focusing lens, and an optical sensor. The light source is for emitting a light beam and projecting the light beam onto the working plane. The reflective mirror is used for reflecting the light beam. The focusing lens is used for focusing the light beam that is reflected from the working plane. The optical sensor is used for receiving the light beam and generating the cursor displacement signal according to the light beam.

In an embodiment, the mouse device further includes a circuit board and a controlling unit. The circuit board is disposed on the casing. The controlling unit is disposed on the circuit board, and connected with the tactile-feel wheel module, the sound button module, the third-axis control module, the silent button module and the displacement sensing module. The controlling unit has a first coordinate system and a second coordinate system. In addition, a rotating angle between the first coordinate system and the second coordinate system is 180 degrees. If the controlling unit detects that the tactile-feel wheel module or the sound button module is triggered, the controlling unit selects the first coordinate system as a default coordinate system and issues the cursor displacement signal corresponding to the first coordinate system. If the controlling unit detects that the third-axis control module or the silent button module is triggered, the controlling unit selects the second coordinate system as the default coordinate system and issues the cursor displacement signal corresponding to the second coordinate system.

In an embodiment, the mouse device further includes a circuit board, a controlling unit, and a mode-switching button. The circuit board is disposed on the casing. The controlling unit is disposed on the circuit board, and connected with the displacement sensing module. The controlling unit has a first coordinate system and a second coordinate system. In addition, a rotating angle between the first coordinate system and the second coordinate system is 180 degrees. The mode-switching button is disposed on the casing and connected with the controlling unit. By pushing the mode-switching button, the mode-switching button issues a mode-switching signal to the controlling unit. According to the mode-switching signal, the controlling unit selects the first coordinate system or the second coordinate system as a default coordinate system.

In an embodiment, the mouse device further includes a wireless signal transmitter and a wireless signal receiver. The wireless signal transmitter is disposed within the casing for issuing the cursor displacement signal, the at least one sound button signal, the at least one silent button signal, a window scrolling signal and an additional window scrolling signal. The wireless signal receiver is connected with the computer system for receiving the cursor displacement signal, the at least one sound button signal, the at least one silent button signal, the window scrolling signal and the additional window scrolling signal.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the connection between a conventional mouse device and a computer system;

FIG. 2 is a schematic perspective view illustrating a portion of the inner structure of the conventional mouse device;

FIG. 3 schematically illustrates the connection between a computer system and a mouse device operable in a sound mode or a silent mode according to a first embodiment of the present invention;

FIG. 4 is a schematic exploded view illustrating the mouse device according to the first embodiment of the present invention;

FIG. 5 is a schematic exploded view illustrating a portion of the mouse device of FIG. 4 and taken along another viewpoint;

FIG. 6 is a schematic side view illustrating a portion of the mouse device according to the first embodiment of the present invention;

FIG. 7 is a schematic side view illustrating the tactile-feel wheel module of the mouse device according to the first embodiment of the present invention;

FIG. 8 is a schematic perspective view illustrating the outer appearance of the mouse device according to the first embodiment of the present invention, in which the mouse device is operated in the sound mode;

FIG. 9 is a schematic perspective view illustrating the outer appearance of the mouse device according to the first embodiment of the present invention, in which the mouse device is operated in the silent mode;

FIG. 10 is a schematic exploded view illustrating a mouse device operable in a sound mode or a silent mode according to a second embodiment of the present invention; and

FIG. 11 is a schematic perspective view illustrating the outer appearance of the mouse device according to the second embodiment of the present invention, in which the mouse device is operated in the silent mode.

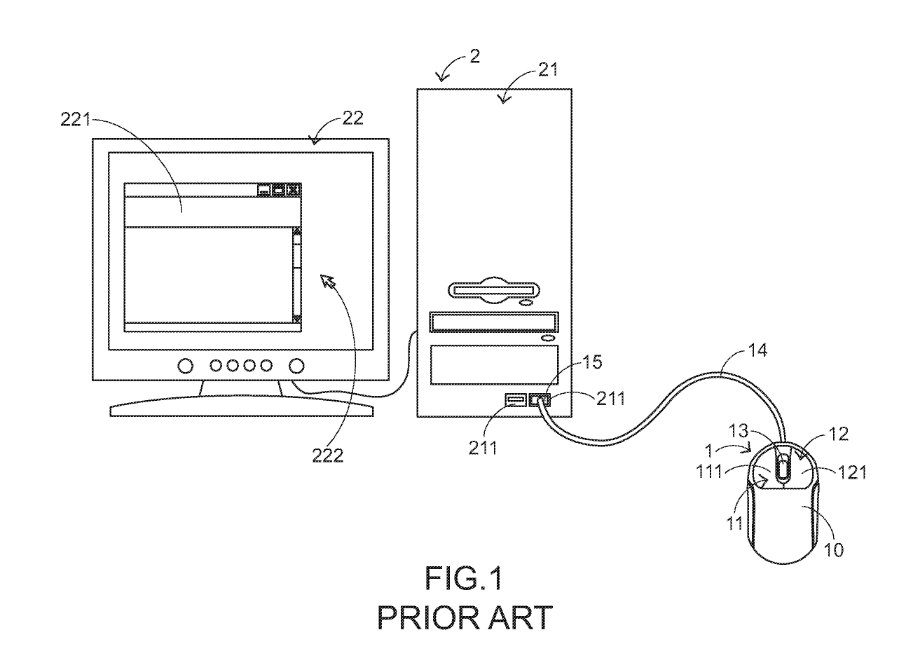

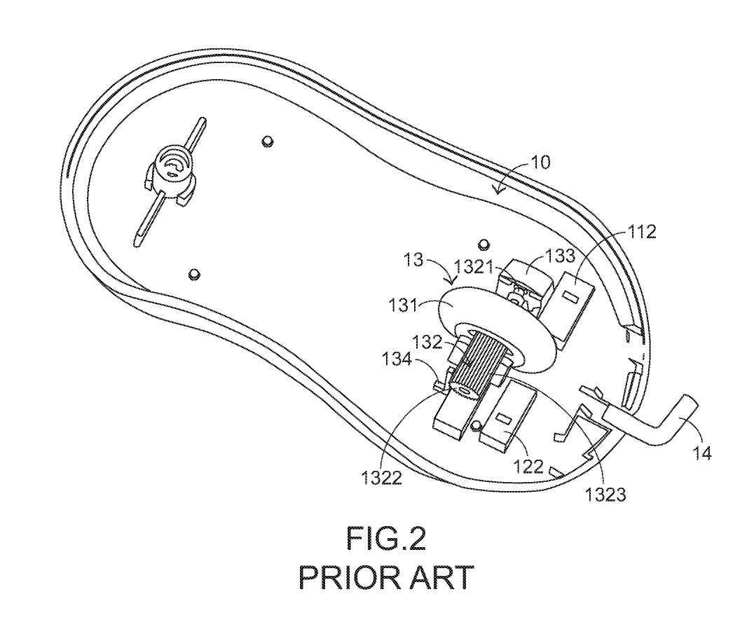

### DETAILED DESCRIPTION OF THE PREFERRED EMBODIMENT

For eliminating the drawbacks encountered from the prior art, the present invention provides a mouse device operable in a sound mode or a silent mode.

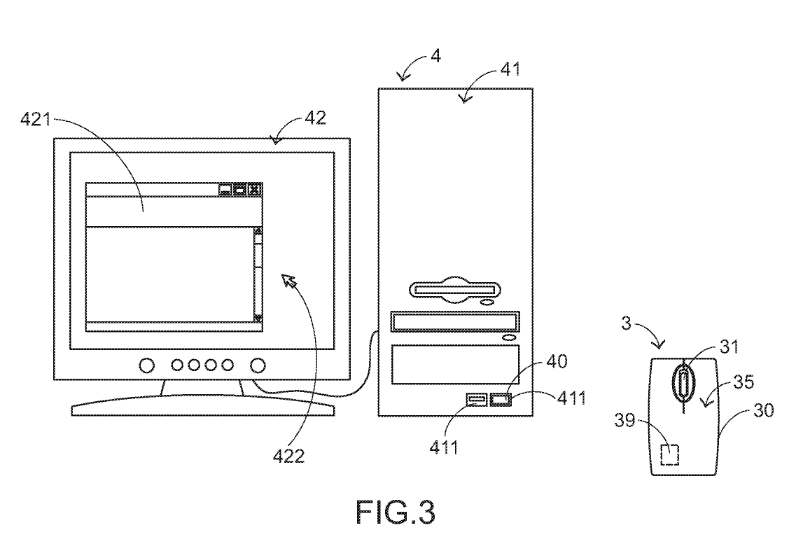

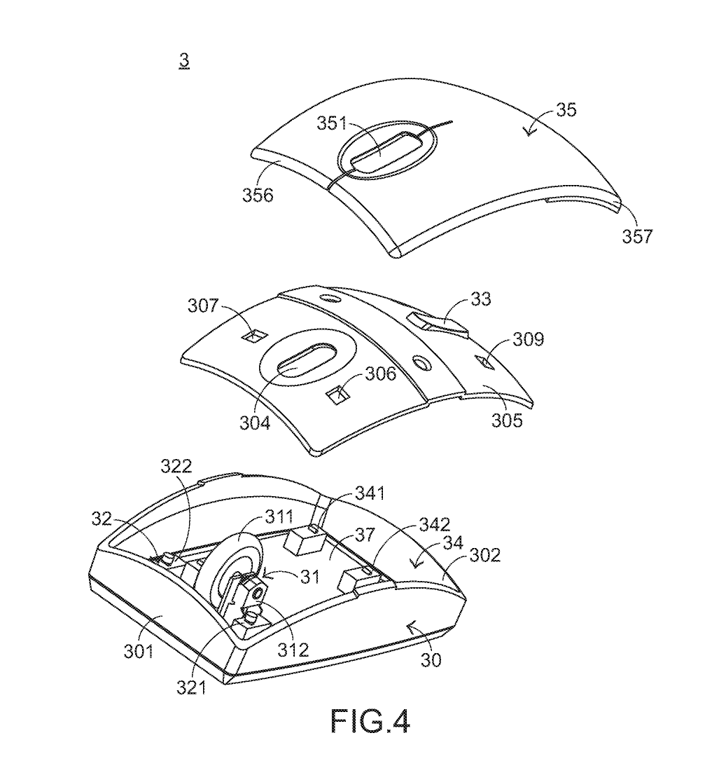

Please refer to FIG. 3 and FIG. 4. FIG. 3 schematically illustrates the connection between a computer system and a mouse device operable in a sound mode or a silent mode according to a first embodiment of the present invention. FIG. 4 is a schematic exploded view illustrating the mouse device according to the first embodiment of the present invention. The mouse device 3 is operable in either the sound mode or the silent mode. In FIG. 3, the mouse device 3 and the computer system 4 are shown. The computer system 4 comprises a computer host 41 and a display screen 42. The computer host 41 is in communication with the mouse device 3 and the display screen 42. The computer host 41 has a connecting port 411. A graphic-based window 421 and a cursor 422 are shown on the display screen 42. The mouse device 3 is in communication with the computer host 41 of the computer system 4. The mouse device 3 is used for controlling the computer system 4, thereby moving the cursor 422 and scrolling the graphic-based window 421.

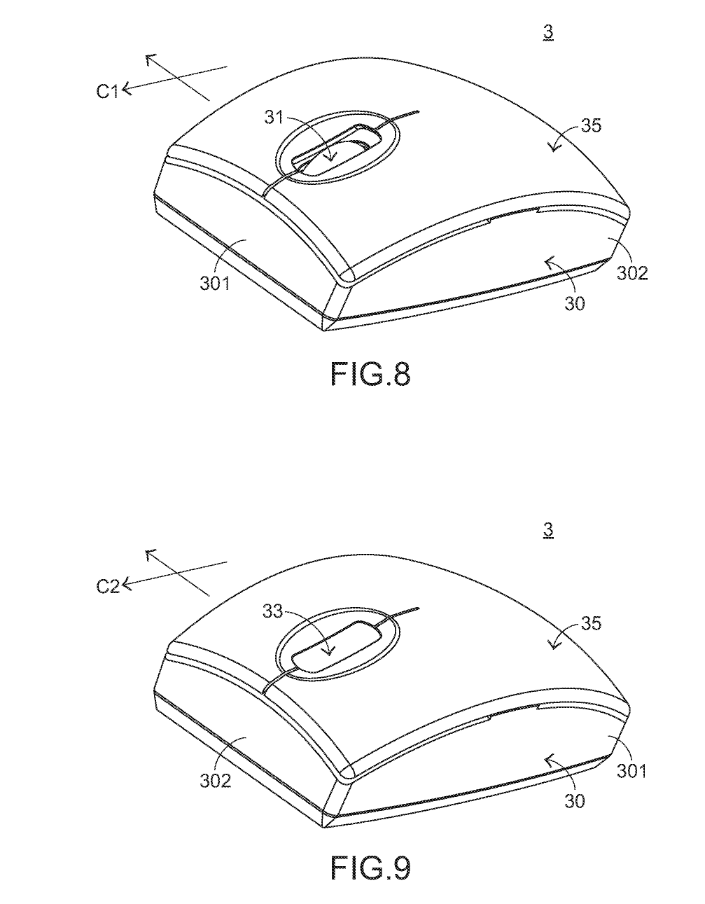

The mouse device 3 comprises a casing 30, a tactile-feel wheel module 31, a sound button module 32, a third-axis control module 33, a silent button module 34, an upper cover 35, a displacement sensing module 36 (see FIG. 8), a circuit board 37, a controlling unit 38 (see FIG. 8), a wireless signal transmitter 39, and a wireless signal receiver 40. The wireless signal transmitter 39 is disposed within the casing 30 and electrically connected with the circuit board 37 for outputting plural signals to the wireless signal receiver 40. The wireless signal receiver 40 is plugged into the connecting port 411 of the computer host 41 for receiving the plural signals from the wireless signal transmitter 39 and transmitting the plural signals to the computer host 41. In other words, the mouse device 3 is communication with the computer host 41 through the wireless signal transmitter 39 and the wireless signal receiver 40.

The components of the mouse device 3 will be illustrated as follows. The casing 30 comprises an opening 304. The tactile-feel wheel module 31 is disposed on the casing 30, and located near a first end 301 of the casing 30. By rotating the tactile-feel wheel module 31, the scroll of the graphic-based window 421 of the computer system 4 is correspondingly controlled. The sound button module 32 is located near the tactile-feel wheel module 31 for issuing at least one sound button signal to the computer system 4. Similar to the tactile-feel wheel module 31, the third-axis control module 33 is disposed on the casing 30 and located near a second end 302 of the casing 30 for controlling the scroll of the graphic-based window 421 of the computer system 4. Similar to the sound button module 32, the silent button module 34 is located near the third-axis control module 33 for issuing at least one silent button signal to the computer system 4.

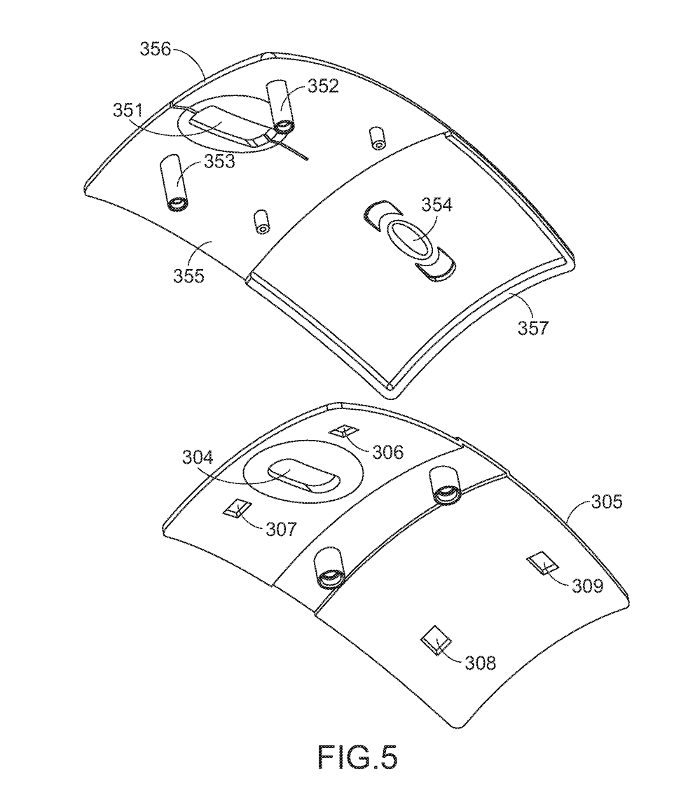

FIG. 5 is a schematic exploded view illustrating a portion of the mouse device of FIG. 4 and taken along another viewpoint. Please refer to FIGS. 4 and 5. The casing 30 is covered by the upper cover 35. Moreover, the upper cover 35 comprises a perforation 351, a first triggering part 352, a second triggering part 353, and a covering part 354. The perforation 351 is located near a first end 356 of the upper cover 35. When the casing 30 is covered by the upper cover 35, the tactile-feel wheel module 31 or the third-axis control module 33 is exposed outside the upper cover 35. The first triggering part 352 is disposed on a bottom surface 355 of the upper cover 35 and located at a first side of the perforation 351 for triggering the sound button module 32 or the silent button module 34. The second triggering part 353 is disposed on the bottom surface 355 of the upper cover 35 and located at a second side of the perforation 351 for triggering the sound button module 32 or the silent button module 34. The covering part 354 is located near a second end 357 of the upper cover 35. When the casing 30 is covered by the upper cover 35, the tactile-feel wheel module 31 or the third-axis control module 33 is covered by the covering part 354. In this embodiment, the covering part 354 is a concave structure. Moreover, the first triggering part 352, the second triggering part 353 and the covering part 354 are integrally formed with the upper cover 35. Alternatively, in some other embodiments, the first triggering part and the second triggering part are disposed on the bottom surface of the upper cover, but are not integrally formed with the upper cover.

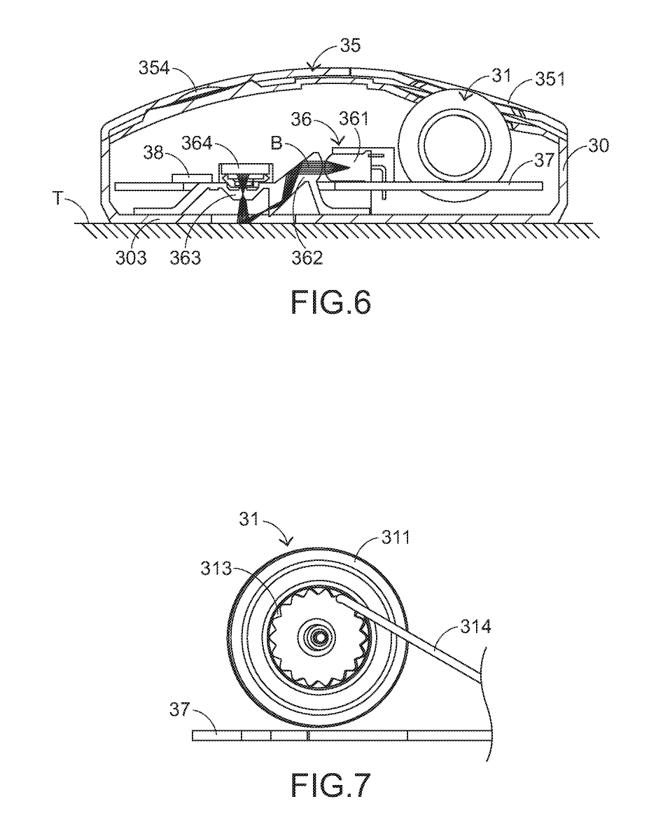

Next, please refer to FIG. 4 and FIG. 6. FIG. 6 is a schematic side view illustrating a portion of the mouse device according to the first embodiment of the present invention. As shown in FIG. 6, the mouse device 3 is placed on a working plane T. The displacement sensing module 36 is disposed within the casing 30, and partially exposed outside a bottom part 303 of the casing 30. According to the movement of the casing 30 on the working plane T, the displacement sensing module 36 generates a cursor displacement signal. According to the cursor displacement signal, the cursor 422 of the computer system 4 is correspondingly moved. The displacement sensing module 36 comprises a light source 361, a reflective mirror 362, a focusing lens 363, and an optical sensor 364. The light source 361 is used for emitting a light beam B. The light beam B is projected onto the working plane T. The reflective mirror 362 is used for reflecting the light beam B. The light beam B reflected from the working plane T is further focused by the focusing lens 363. The optical sensor 364 is used for receiving the light beam B and generating a cursor displacement signal according to the light beam B. In this embodiment, the light source 361 is a light emitting diode (LED).

The circuit board 37 is disposed on the casing 30, and electrically connected with the tactile-feel wheel module 31, the sound button module 32, the third-axis control module 33, the silent button module 34, the displacement sensing module 36, the controlling unit 38 and the wireless signal transmitter 39. The tactile-feel wheel module 31, the sound button module 32, the silent button module 34, the displacement sensing module 36 and the wireless signal transmitter 39 are also supported on the circuit board 37. The controlling unit 38 is disposed on the circuit board 37, and connected with the tactile-feel wheel module 31, the sound button module 32, the third-axis control module 33, the silent button module 34 and the displacement sensing module 36 through the circuit board 37. A first coordinate system C1 (see FIG. 8) and a second coordinate system C2 (see FIG. 9) have been previously set in the controlling unit 38. If the controlling unit 38 detects that the tactile-feel wheel module 31 or the sound button module 32 is triggered, the controlling unit 38 will select the first coordinate system C1 as a default coordinate system and issue a cursor displacement signal corresponding to the first coordinate system C1. If the controlling unit 38 detects that the third-axis control module 33 or the silent button module 34 is triggered, the controlling unit 38 will select the second coordinate system C2 as the default coordinate system and issue a cursor displacement signal corresponding to the second coordinate system C2. In this embodiment, a rotating angle between the first coordinate system C1 and the second coordinate system C2 is 180 degrees. Moreover, in this embodiment, the controlling unit 38 is a firmware component, which is disposed on the circuit board 37.

Next, please refer to FIG. 4 and FIG. 7. FIG. 7 is a schematic side view illustrating the tactile-feel wheel module of the mouse device according to the first embodiment of the present invention. The tactile-feel wheel module 31 comprises a scroll wheel 311, an encoder 312, a graduation structure 313, and a contacting element 314. The scroll wheel 311 is disposed on the casing 30. Moreover, the scroll wheel 311 is partially penetrated through the opening 304 of the casing 30 and exposed outside a top surface 305 of the casing 30, so that the scroll wheel 311 is rotatable by the user. The encoder 312 is connected with the scroll wheel 311. In response to the rotation of the scroll wheel 311, the encoder 312 issues a window scrolling signal to the computer system 4 for controlling the scroll of the graphic-based window 421. The graduation structure 313 is disposed within the scroll wheel 311, and synchronously rotated with the scroll wheel 311. The contacting element 314 is contacted with the graduation structure 313. As the scroll wheel 311 is rotated, the contact between the contacting element 314 and the graduation structure 313 results in a tactile feel. In this embodiment, the contacting element 314 is a contacting rod.

Please refer to FIG. 4 again. The third-axis control module 33 is disposed on the top surface 305 of the casing 30, and electrically connected with the circuit board 37 and the controlling unit 38. For clearly showing the components of the third-axis control module 33, the electric connection relationships between the third-axis control module 33, the circuit board 37 and the controlling unit 38 are not shown in FIG. 4. In a case that a finger of the user is placed on the third-axis control module 33 and moved on the third-axis control module 33, a window scrolling signal corresponding to a moving direction of the user's finger is issued from the third-axis control module 33 to the computer system for controlling the scroll of the graphic-based window 421. In this embodiment, the third-axis control module 33 is a capacitive touchpad. Alternatively, in some other embodiments, the third-axis control module is a resistive touchpad, an optical finger navigation (OFN) module or a membrane switch circuit module. In a case that the third-axis control module is a membrane switch circuit module, the membrane switch circuit module comprises plural electrical contacts, which are arranged in a row. When the user's finger is moved on the membrane switch circuit module, the plural electrical contacts arranged in the row are sequentially triggered. Consequently, the controlling unit issues a corresponding window scrolling signal.

Please refer to FIG. 4 and FIG. 5 again. The sound button module 32 comprises a first micro switch 321 and a second micro switch 322. The first micro switch 321 is located at a first side of the tactile-feel wheel module 31. If the mouse device 3 is operated in the sound mode, when the first micro switch 321 is pressed by the first triggering part 352 of the upper cover 35, the first micro switch 321 generates a first sound button signal. The second micro switch 322 is located at a second side of the tactile-feel wheel module 31. If the mouse device 3 is operated in the sound mode, when the second micro switch 322 is pressed by the second triggering part 353 of the upper cover 35, the second micro switch 322 generates a second sound button signal. During the first micro switch 321 or the second micro switch 322 is pressed, a clicking sound is generated.

The silent button module 34 comprises a first silent switch 341 and a second silent switch 342. The first silent switch 341 is located at a first side of the third-axis control module 33. If the mouse device 3 is operated in the silent mode, when the first silent switch 341 is pressed by the first triggering part 352, the first silent switch 341 generates a first silent button signal. The second silent switch 342 is located at a second side of the third-axis control module 33. If the mouse device 3 is operated in the silent mode, when the second silent switch 342 is pressed by the second triggering part 353, the second silent switch 342 generates a second silent button signal. During the first silent switch 341 or the second silent switch 342 is pressed, no clicking sound is generated.

In this embodiment, both of the first silent switch 341 and the second silent switch 342 are Hall silent switches. Alternatively, in some other embodiments, each of the first silent switch 341 and the second silent switch 342 is a mechanical silent switch, a Hall silent switch or a photoelectric silent switch. The structures of the above silent switches are well known to those skilled in the art, and are not redundantly described herein.

Please refer to FIG. 4 and FIG. 5 again. The casing 30 further comprises a first hole 306, a second hole 307, a third hole 308, and a fourth hole 309. The first hole 306 is disposed over the first micro switch 321. The second hole 307 is disposed over the second micro switch 322. The third hole 308 is disposed over the first silent switch 341. The fourth hole 309 is disposed over the second silent switch 342.

For operating the mouse device 3 in the sound mode, the first end 356 of the upper cover 35 is firstly aligned with the first end 301 of the casing 30 while the perforation 351 of the upper cover 35 is aligned with the scroll wheel 311. After the top surface 305 of the casing 30 is covered by the upper cover 35, the scroll wheel 311 is exposed outside the upper cover 35, so that the scroll wheel 311 is rotatable by the user. Under this circumstance, the third-axis control module 33 is simultaneously covered by the covering part 354, and thus the third-axis control module 33 will not be erroneously touched. On the other hand, the first triggering part 352 is penetrated through the first hole 306, and disposed over the first micro switch 321. The second triggering part 353 is penetrated through the second hole 307, and disposed over the second micro switch 322. Similar to the third-axis control module 33, the silent button module 34 is also covered by the upper cover 35 and unable to be triggered. The outer appearance of the mouse device 3 in the sound mode is shown in FIG. 8.

For switching the operating mode of the mouse device 3 from the sound mode to the silent mode, the upper cover 35 is firstly detached from the casing 30, and the casing 30 is rotated by 180 degrees. Then, the first end 356 of the upper cover 35 is aligned with the second end 302 of the casing 30 while the perforation 351 of the upper cover 35 is aligned with the third-axis control module 33. After the top surface 305 of the casing 30 is covered by the upper cover 35, the third-axis control module 33 is exposed outside the upper cover 35, so that the third-axis control module 33 is touchable by the user. Under this circumstance, the scroll wheel 311 is simultaneously covered by the covering part 354, and thus the scroll wheel 311 will not be erroneously touched. On the other hand, the first triggering part 352 is penetrated through the third hole 308, and disposed over the first silent switch 341. The second triggering part 353 is penetrated through the fourth hole 309, and disposed over the second silent switch 342. Similar to the scroll wheel 311, the sound button module 32 is also covered by the upper cover 35 and unable to be triggered. The outer appearance of the mouse device 3 in the silent mode is shown in FIG. 9.

If the mouse device 3 is operated in the sound mode, the user may firstly trigger the tactile-feel wheel module 31 or the sound button module 32. According to the triggered state of the tactile-feel wheel module 31 or the sound button module 32, the controlling unit 38 judges that the mouse device 3 is in the sound mode. As the casing 30 is moved in a specified direction (e.g. the right direction), the displacement sensing module 36 generates a cursor displacement signal according to the movement of the casing 30, and the cursor displacement signal is issued to the controlling unit 38. Since controlling unit 38 judges that the mouse device 3 is in the sound mode, the controlling unit 38 will select the first coordinate system C1 as the default coordinate system and issue the cursor displacement signal corresponding to the first coordinate system C1 to the computer system 4. According to the cursor displacement signal, the cursor 422 is moved in the right direction by the computer host 41.

Similarly, if the mouse device 3 is operated in the silent mode, the user may firstly trigger the third-axis control module 33 or the silent button module 34. According to the triggered state of the third-axis control module 33 or the silent button module 34, the controlling unit 38 judges that the mouse device 3 is in the silent mode. As the casing 30 is moved in the specified direction (e.g. the right direction), the displacement sensing module 36 generates a cursor displacement signal according to the movement of the casing 30, and the cursor displacement signal is issued to the controlling unit 38. Since controlling unit 38 judges that the mouse device 3 is in the silent mode, the controlling unit 38 will select the second coordinate system C2 as the default coordinate system and issue the cursor displacement signal corresponding to the second coordinate system C2 to the computer system 4. The rotating angle between the first coordinate system C1 and the second coordinate system C2 is 180 degrees. According to the cursor displacement signal, the cursor 422 is moved in the right direction by the computer host 41.

If the first coordinate system C1 and the second coordinate system C2 are not previously set by the controlling unit 38, some problems may occur. For example, if the mouse device 3 is in the sound mode and the casing 30 is moved in the right direction, the cursor 422 is moved in the right direction by the computer host 41. However, if the mouse device 3 is in the silent mode and the casing 30 is moved in the right direction, since the casing 30 is rotated by 180 degrees, the displacement sensing module 36 is also rotated by 180 degrees. Since the right-direction movement of the casing 30 is considered as a left-direction movement by the displacement sensing module 36, the displacement sensing module 36 issues a cursor displacement signal corresponding to the left-direction movement. According to the cursor displacement signal, the cursor 422 is moved in the left direction by the computer host 41. Under this circumstance, an erroneous action is generated. In other words, the way of previously setting the first coordinate system C1 and the second coordinate system C2 are beneficial to minimize the erroneous action.

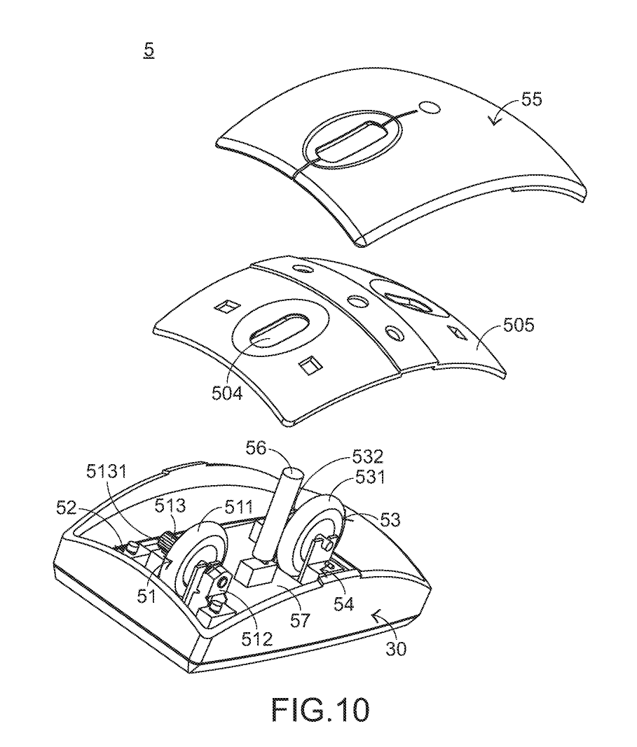

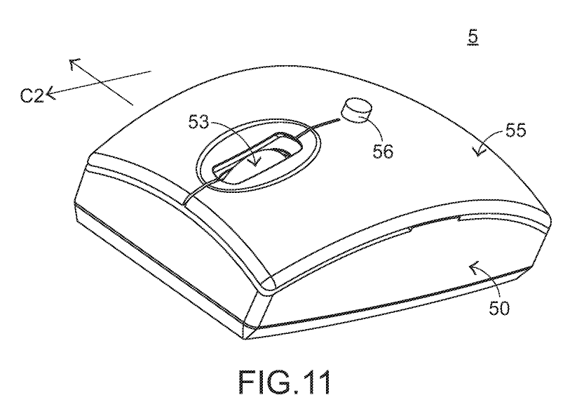

Moreover, the present invention further comprises a mouse device operable in a sound mode or a silent mode according to a second embodiment of the present invention. FIG. 10 is a schematic exploded view illustrating a mouse device operable in a sound mode or a silent mode according to a second embodiment of the present invention. FIG. 11 is a schematic perspective view illustrating the outer appearance of the mouse device according to the second embodiment of the present invention, in which the mouse device is operated in the silent mode.

Please refer to FIGS. 10 and 11. The mouse device 5 comprises a casing 50, a tactile-feel wheel module 51, a sound button module 52, a third-axis control module 53, a silent button module 54, an upper cover 55, a displacement sensing module (not shown), a circuit board 57, a controlling unit (not shown), a wireless signal transmitter (not shown), a wireless signal receiver (not shown), and a mode-switching button 56. Except for the following items, the components of the mouse device 5 of the second embodiment are substantially identical to those of the mouse device 3 of the first embodiment, and are not redundantly described herein.

The following three items of the mouse device 5 of this embodiment are distinguished from those of the mouse device 3 of the first embodiment.

Firstly, the tactile-feel wheel module 51 comprises a scroll wheel 511, an encoder 512, a rotating shaft 513, and a contacting element (not shown). The scroll wheel 511 is disposed on the casing 50. Moreover, the scroll wheel 511 may be penetrated through an opening 504 of the casing 50 and exposed outside a top surface 505 of the casing 50 to be rotated by the user. The rotating shaft 513 is penetrated through the scroll wheel 511, and synchronously rotated with the scroll wheel 511. The encoder 512 is disposed on the casing 50, and located at a first side of the scroll wheel 511. A first end of the rotating shaft 513 is inserted into the encoder 512. As the scroll wheel 511 is rotated and the rotating shaft 513 is synchronously rotated with the scroll wheel 511, the encoder 512 issues a window scrolling signal. The rotating shaft 513 comprises a graduation structure 5131. The graduation structure 5131 is disposed on a second end of the rotating shaft 513. In this embodiment, the graduation structure 5131 comprises plural saw-toothed structures. The contacting element is contacted with the graduation structure 5131. As the scroll wheel 511 is rotated, the contact between the contacting element and the graduation structure 5131 results in a tactile feel.

Secondly, the third-axis control module 53 comprises an additional scroll wheel 531 and an additional encoder 532. The additional scroll wheel 531 is disposed on the casing 50. Moreover, the additional scroll wheel 531 may be penetrated through the opening 504 of the casing 50 and exposed outside the top surface 505 of the casing 50 to be rotated by the user. The additional encoder 532 is connected with the additional scroll wheel 531. In response to the rotation of the additional scroll wheel 531, the additional encoder 532 issues a window scrolling signal to the computer system (not shown) for controlling the scroll of the graphic-based window (not shown). Since the third-axis control module 53 has no contacting element to be contacted with the additional scroll wheel 531, the rotation of the additional scroll wheel 531 does not result in the tactile feel.

Thirdly, the mouse device 5 further comprises the mode-switching button 56. The mode-switching button 56 is disposed on the casing 50, and electrically connected with the controlling unit. By pushing the mode-switching button 56, the mode-switching button 56 issues a mode-switching signal to the controlling unit. According to the mode-switching signal, the controlling unit selects the first coordinate system C1 or the second coordinate system C2 as the default coordinate system. In this embodiment, the controlling unit does not need to be connected with the tactile-feel wheel module 51, the sound button module 52, the third-axis control module 53 and the silent button module 54 to judge whether the tactile-feel wheel module 51, the sound button module 52, the third-axis control module 53 or the silent button module 54 is triggered. Under this circumstance, the controlling unit can still realize whether the mouse device 5 is in the sound mode or the silent mode. That is, by pushing the mode-switching button 56, the first coordinate system C1 or the second coordinate system C2 may be selected as the default coordinate system by the user.

From the above descriptions, the present invention provides a mouse device. The mouse device is selectively operated in a sound mode or a silent mode for making a clicking sound or not making the clicking sound. In the silent mode, since the mouse device does not make the clicking sound, the mouse device is suitably used in the quiet environment. In the sound mode, the mouse device of the present invention can meet the requirement of the users which are accustomed to the use of the tactile-feel scroll wheel. Under this circumstance, the function of resulting in the tactile feel of the scroll wheel can be maintained.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A mouse device operable in a sound mode or a silent mode, said mouse device being in communication with a computer system for controlling a movement of a cursor of said computer system, said mouse device comprising:
a casing;
a tactile-feel wheel module disposed on said casing, and located near a first end of said casing, wherein as said tactile-feel wheel module is rotated, a window of said computer system is correspondingly controlled to be scrolled;
a sound button module located near said tactile-feel wheel module for issuing at least one sound button signal to said computer system;
a third-axis control module disposed on said casing and located near a second end of said casing for controlling said window of said computer system to be scrolled; and
a silent button module located near said third-axis control module for issuing at least one silent button signal to said computer system.

2. The mouse device according to claim 1, further comprising an upper cover for covering said casing, wherein said upper cover comprises:
a perforation located near a first end of said upper cover, wherein when said casing is covered by said upper cover, said tactile-feel wheel module or said third-axis control module is exposed outside said upper cover;
a first triggering part disposed on a bottom surface of said upper cover and located at a first side of said perforation for triggering said sound button module or said silent button module;
a second triggering part disposed on said bottom surface of said upper cover and located at a second side of said perforation for triggering said sound button module or said silent button module; and
a covering part located near a second end of said upper cover, wherein when said casing is covered by said upper cover, said tactile-feel wheel module or said third-axis control module is covered by said covering part.

3. The mouse device according to claim 2, wherein said sound button module comprises:
a first micro switch located at a first side of said tactile-feel wheel module, wherein when said first micro switch is pressed by said first triggering part, said first micro switch generates a first sound button signal; and
a second micro switch located at a second side of said tactile-feel wheel module, wherein when said second micro switch is pressed by said second triggering part, said second micro switch generates a second sound button signal,
wherein if said mouse device is operated in said sound mode, said first micro switch is disposed under said first triggering part, and said second micro switch is disposed under said second triggering part.

4. The mouse device according to claim 2, wherein said silent button module comprises:
a first silent switch located at a first side of said third-axis control module, wherein when said first silent switch is pressed by said first triggering part, said first silent switch generates a first silent button signal; and
a second silent switch located at a second side of said third-axis control module, wherein when said second silent switch is pressed by said second triggering part, said second silent switch generates a second silent button signal,
wherein if said mouse device is operated in said silent mode, said first silent switch is disposed under said first triggering part, and said second silent switch is disposed under said second triggering part.

5. The mouse device according to claim 4, wherein each of said first silent switch and said second silent switch is a mechanical silent switch, a Hall silent switch or a photoelectric silent switch.

6. The mouse device according to claim 1, wherein said tactile-feel wheel module comprises:
a scroll wheel disposed on said casing, partially penetrated through an opening of said casing and exposed outside a top surface of said casing, so that said scroll wheel is permitted to be rotated;
an encoder connected with said scroll wheel, wherein as said scroll wheel is rotated, said encoder issues a window scrolling signal to said computer system for controlling said window to be scrolled;
a graduation structure synchronously rotated with said scroll wheel; and
a contacting element contacted with said graduation structure, wherein as said scroll wheel is rotated, a tactile feel is generated.

7. The mouse device according to claim 1, wherein said third-axis control module comprises:
a scroll wheel disposed on said casing, partially penetrated through an opening of said casing and exposed outside a top surface of said casing, so that said scroll wheel is permitted to be rotated; and
an encoder connected with said scroll wheel, wherein as said scroll wheel is rotated, said encoder issues a window scrolling signal to said computer system for controlling said window to be scrolled.

8. The mouse device according to claim 1, wherein said third-axis control module is disposed on a top surface of said casing, wherein said third-axis control module is a capacitive touchpad, a resistive touchpad, an optical finger navigation (OFN) module or a membrane switch circuit module.

9. The mouse device according to claim 1, further comprising a displacement sensing module, wherein said displacement sensing module is disposed within said casing and partially exposed to a bottom part of said casing, wherein according to a movement of said casing on a working plane, said displacement sensing module issues a cursor displacement signal for controlling said movement of said cursor of said computer system.

10. The mouse device according to claim 9, wherein said displacement sensing module comprises:
a light source for emitting a light beam and projecting said light beam onto said working plane;
a reflective mirror for reflecting said light beam;
a focusing lens for focusing said light beam that is reflected from said working plane; and
an optical sensor for receiving said light beam and generating said cursor displacement signal according to said light beam.

11. The mouse device according to claim 9, further comprising:
a circuit board disposed on said casing;
a controlling unit disposed on said circuit board, and connected with said tactile-feel wheel module, said sound button module, said third-axis control module, said silent button module and said displacement sensing module, wherein said controlling unit has a first coordinate system and a second coordinate system, and a rotating angle between said first coordinate system and said second coordinate system is 180 degrees, wherein if said controlling unit detects that said tactile-feel wheel module or said sound button module is triggered, said controlling unit selects said first coordinate system as a default coordinate system and issues said cursor displacement signal corresponding to said first coordinate system, wherein if said controlling unit detects that said third-axis control module or said silent button module is triggered, said controlling unit selects said second coordinate system as said default coordinate system and issues said cursor displacement signal corresponding to said second coordinate system.

12. The mouse device according to claim 9, further comprising:
a circuit board disposed on said casing;
a controlling unit disposed on said circuit board, and connected with said displacement sensing module, wherein said controlling unit has a first coordinate system and a second coordinate system, and a rotating angle between said first coordinate system and said second coordinate system is 180 degrees; and
a mode-switching button disposed on said casing and connected with said controlling unit, wherein by pushing said mode-switching button, said mode-switching button issues a mode-switching signal to said controlling unit, wherein according to said mode-switching signal, said controlling unit selects said first coordinate system or said second coordinate system as a default coordinate system.

13. The mouse device according to claim 9, further comprising a wireless signal transmitter and a wireless signal receiver, wherein said wireless signal transmitter is disposed within said casing for issuing said cursor displacement signal, said at least one sound button signal, said at least one silent button signal, a window scrolling signal and an additional window scrolling signal, wherein said wireless signal receiver is connected with said computer system for receiving said cursor displacement signal, said at least one sound button signal, said at least one silent button signal, said window scrolling signal and said additional window scrolling signal.
